(19) United States
(12) Patent Application Publication
(10) Pub. No.: US 2023/0144977 A1
(43) Pub. Date: May 11, 2023

(54) PROVIDING FORM SERVICE ASSISTANCE

(71) Applicant: Microsoft Technology Licensing, LLC, Redmond, WA (US)

(72) Inventors: Si MENG, Beijing (CN); Si-Qing CHEN, Bellevue, WA (US); Sun MAO, Redmond, WA (US); Tao WU, Redmond, WA (US); Fangrong CHEN, Redmond, WA (US); Siliang PI, Redmond, WA (US); Genglin HUANG, Redmond, WA (US); Anqi Du, Redmond, WA (US); Kun LIU, Redmond, WA (US); Xiaofei YANG, Redmond, WA (US); Yamin WANG, Redmond, WA (US)

(21) Appl. No.: 17/913,034

(22) PCT Filed: Feb. 23, 2021
(86) PCT No.: PCT/US2021/019143

§ 371 Date: Sep. 20, 2022

(30) Foreign Application Priority Data
Apr. 22, 2020 (CN) 202010325671.0

(51) Int. Cl. G06F 40/186; G06F 40/279; G06F 3/0484; G06F 3/0482

(52) U.S. Cl. CPC G06F 40/186; G06F 3/0482; G06F 3/0484; G06F 40/279

(57) ABSTRACT

The present disclosure provides methods and apparatuses for providing form service assistance. Feature information corresponding to content in a target application may be extracted. It may be determined, based at least on the feature information, to recommend a form service for the content. A recommendation prompt of the form service may be presented. In response to receiving a confirmation to the recommendation prompt, the form service may be initiated with at least the feature information.

### BACKGROUND

Form service is a data collection service widely used for collecting data through forms. For example, a user who desires to collect data may create a form through the form service, and distribute the form to multiple recipients through various approaches. One or more recipients may respond to the form through filling information into the form. Thus, the user who desires to collect data may obtain, through the form service, data provided by those recipients having responded to the form. The user creating the form may be referred to as a form creator, recipients receiving the form may be referred to as form recipients, and recipients responding to the form may be referred to as form responders. The form service may be applied for various purposes, e.g., performing survey, poll, quiz, etc.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose methods and apparatuses for providing form service assistance. Feature information corresponding to content in a target application may be extracted. It may be determined, based at least on the feature information, to recommend a form service for the content. A recommendation prompt of the form service may be presented. In response to receiving a confirmation to the recommendation prompt, the form service may be initiated with at least the feature information.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates exemplary scenarios of providing form service assistance according to an embodiment.

FIG. 2 illustrates an exemplary process for providing form service assistance according to an embodiment.

FIG. 3 illustrates an exemplary process for triggering form service recommendation according to an embodiment.

FIG. 4 illustrates an exemplary process for assisting to create a form according to an embodiment.

FIG. 5A to FIG. 5B illustrate an example of providing a recommendation prompt of a form service according to an embodiment.

FIG. 6 illustrates an example of providing a recommendation prompt of a form service according to an embodiment.

FIG. 7A to FIG. 7B illustrate an example of initiating a form service and assisting to create a form according to an embodiment.

FIG. 8A to FIG. 8C illustrate an example of initiating a form service and assisting to create a form according to an embodiment.

FIG. 9 to FIG. 10 illustrate an example of presenting a form at a form recipient according to an embodiment.

FIG. 11 illustrates an example of presenting a response result of a form at a form creator according to an embodiment.

FIG. 12A to FIG. 12B illustrate an example of providing a recommendation prompt of a form service according to an embodiment.

FIG. 13 illustrates an example of providing a recommendation prompt of a form service according to an embodiment.

FIG. 14 illustrates an example of initiating a form service and assisting to create a form according to an embodiment.

FIG. 15 illustrates an example of assisting to create a form according to an embodiment.

FIG. 16 illustrates an example of assisting to create a distribution email according to an embodiment.

FIG. 17 to FIG. 18 illustrate an example of presenting a response result of a form according to an embodiment.

FIG. 19 illustrates a flowchart of an exemplary method for providing form service assistance according to an embodiment.

FIG. 20 illustrates an exemplary apparatus for providing form service assistance according to an embodiment.

FIG. 21 illustrates an exemplary apparatus for providing form service assistance according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

A form service enables people to collect data or information more efficiently and conveniently. Usually, when a user desires to use a form service, the user needs to assess a form application proactively. Herein, the form application may widely refer to various web applications, clients, servers, network platforms, etc. capable of providing a form service. However, people often cannot timely recognize that they need to use a form service. For example, when a user is attempting to ask for opinions of multiple recipients through an email, it is very likely that the user does not recognize that he may collect opinions through a form service efficiently at this moment.

Embodiments of the present disclosure propose to provide accurate and efficient form service assistance, when identifying that a user has a potential need of a form service and during the user is using the form service.

In an aspect, the embodiments of the present disclosure may identify a user’s potential need of a form service in a target application used by the user, and proactively recommend the form service to the user, thus providing assistances to the triggering and initiating of the form service. Herein, the target application may widely refer to various applications used by users, e.g., productivity tools, etc. The productivity tools may comprise, e.g., email service, calendar application, document processing application, network meeting application, social media software, etc. A user’s potential need of a form service may refer to that the user may use the form service or possibly needs to use the form service, for achieving a certain purpose in a target application. When the user is processing content with the target application, various types of feature information may be extracted from the content, which may facilitate to identify whether there is a potential need of a form service and may be further used to determine whether the form service should be recommended to the user. For example, through a pre-established trigger model, it may be determined, based on the feature information, whether to recommend a form service. Through proactively recommending a form service to a user in the case that the user has a potential need of the form service, the embodiments of the present disclosure may assist to trigger and initiate the form service timely and accurately, promote the usage rate of the form service effectively, help the user to improve data collection efficiency through the form service, etc.

In another aspect, the embodiments of the present disclosure may provide assistances to the usage of a form service during a user is using the form service. The feature information collected in the process of determining to recommend the form service may be transferred to the whole lifecycle of the form service for providing assistances to the usage of the form service, e.g., assisting a form creator to create and distribute a form, assisting a form responder to respond to a form, assisting to generate a response result, etc. Therefore, the embodiments of the present disclosure may significantly increase the usage rate of a form service, improve user experiences, etc.

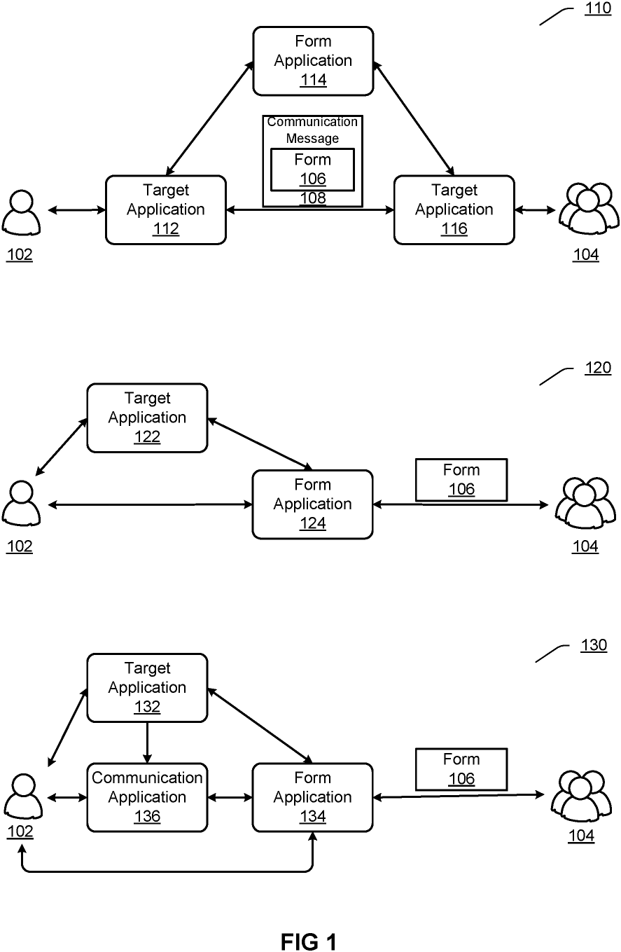

FIG. 1 illustrates exemplary scenarios of providing form service assistance according to an embodiment. In these scenarios, the embodiments of the present disclosure may provide assistances in the triggering and usage of a form service.

In an exemplary scenario 110, a user 102 may be using or has already used a target application 112, e.g., a client of an email service, etc. When it is identified in the target application 112 that the user 102 has a potential need of a form service, the form service may be recommended to the user 102, e.g., a recommendation prompt of the form service may be presented to the user 102 in the target application 112. When a confirmation to the recommendation prompt is obtained from the user 102, e.g., when the user 102 indicates that the user desires to use the form service, the form service may be initiated and provided in the target application 112. The user 102 may carry out the creating and editing of a form 106 in the target application 112. At this point, the user 102 becomes a form creator. The form service may be implemented by a form application 114 in the target application 112 in an embedded approach, thus the form creator 102 does not need to directly access the form application 114, but may obtain the form service in the target application 112. It is assumed that the target application 112 has the capability of creating and transferring communication messages. Herein, the communication messages may refer to any types of message that can carry information or data, e.g., email, social media message, cellphone short message, etc. Accordingly, the target application 112 may be an application capable of supporting these communication messages, e.g., an email service client, social media software, a cellphone short message service, etc. The created form 106 may be included in a communication message 108 generated by the target application 112, and sent to at least one recipient 104. The recipient 104 may obtain the communication message 108 including the form 106 through a target application 116. The target application 116 may be the same as the target application 112 or have the capability of communicating with the target application 112. The recipient 104 may access the form service in the target application 116 and complete the responding to the form 106, e.g., filling information in the form 106. The form service may be implemented by the form application 114 in the target application 116 in an embedded approach. Thus, the recipient 104 does not need to directly access the form application 114, but may complete the responding to the form in the target application 116. The recipient 104 who responds to the form becomes a form responder. The form submitted by the form responder 104 may be transferred from the target application 116 back to the target application 112, so that the form creator 102 may obtain the desired data. Moreover, the form application 114 may collect responses from different responders, and provide a response result of the form 106 through the target application 112 and/or 116. In the scenario 110, the target application may have the capability of transferring the communication message, have the processing capability of supporting the presenting of the recommendation prompt of the form service, have the processing capability of supporting the usage of the form services in an embedded approach, etc. The processing capabilities of the target application may include, e.g., data processing capability, user interface presenting capability, etc. Therefore, the user may obtain the recommendation prompt of the form service, use the form service, etc., in the target application.

In an exemplary scenario 120, a user 102 may be using or has already used a target application 122, e.g. a calendar application. When it is identified in the target application 122 that the user 102 has a potential need of a form service, the form service may be recommended to the user 102, e.g., a recommendation prompt of the form service may be presented to the user 102 in the target application 122. When a confirmation to the recommendation prompt is obtained from the user 102, the user 102 may be guided from the target application 122 to a form application 124, and the form service may be initiated and provided in the form application 124. The user 102 may carry out the creating and editing of a form 106 in the form application 124. At this point, the user 102 becomes a form creator. The form application 124 may provide and present the form 106 to at least one recipient 104 through any approaches. For example, a link associated with the form 106 may be notified to the recipient 104, so that the recipient 104 may obtain the form 106 by accessing the link. The recipient 104 may complete the responding to the form 106 through the form application 124. The recipient 104 who responds to the form becomes a form responder. The form application 124 may collect responses from different responders, and provide a response result of the form 106 to the form creator 102 and/or the form responder 104. In the scenario 120, the target application may have the processing capability of supporting the presenting of the recommendation prompt of the form service, and the usage of the form service is implemented in the form application 124. Therefore, compared with the target application 112, the target application 122 is not required to have the processing capability of supporting the usage of the form service.

In an exemplary scenario 130, a user 102 may be using or has already used a target application 132, e.g. a calendar application. When it is identified in the target application 132 that the user 102 has a potential need of a form service, the form service may be recommended to the user 102, e.g., a recommendation prompt of the form service may be presented to the user 102 in a communication application 136. The communication application 136 may be various applications that support the creating and transferring of communication messages, e.g., an email service, social media software, a cellphone short message service, etc. When a confirmation to the recommendation prompt is obtained from the user 102, the user 102 may be guided to a form application 134, and the form service may be initiated and provided in the form application 134. The user 102 may carry out the creating and editing of a form 106 in the form application 134. At this point, the user 102 becomes a form creator. The form application 134 may provide and present the form 106 to at least one recipient 104 through any approaches. The recipient 104 may complete the responding to the form 106 through the form application 134. The recipient 104 who responds to the form becomes a form responder. The form application 134 may collect responses from different responders, and provide, directly or through the communication application 136, a response result of the form 106 to the form creator 102 and/or the form responder 104. In the scenario 130, the recommendation prompt of the form service is presented to the user by the communication application 136, and the usage of the form service is implemented in the form application 134. Therefore, compared with the target applications 112 and 122, the target application 132 is not required to have the processing capability of supporting the presenting of the recommendation prompt of the form service, the processing capability of supporting the usage of the form service, etc.

In the above exemplary scenarios 110, 120 and 130, a user’s potential need of a form service may be identified in a target application used by the user, and the form service may be proactively recommended to the user, thus guiding the user to initiate and use the form service. The identifying of the user’s potential need of the form service may be performed in real time, periodically, in response to any triggers, etc. Through providing such assistance to the triggering and initiating of the form service, this may promote the usage rate of the form service more effectively, help the user to improve data collection efficiency through the form service, etc. Moreover, feature information extracted from the target application may also be used to provide usage assistances during the whole lifecycle of the form service, thereby, the usage rate of the form service may be significantly increased, user experiences may be improved, etc. It should be understood that the triggering of the form service, e.g., determining whether to recommend the form service, may be performed by the form application or performed by the target application, and the embodiments of the present disclosure are not limited in this respect. For example, the form application may perform real-time or non-real-time monitoring in the target application to determine whether to recommend the form service, or the target application may have a function of performing real-time or non-real-time monitoring to determine whether to recommend the form service. Moreover, it should be understood that only several exemplary application scenarios are shown in FIG. 1, and the embodiments of the present disclosure are not limited to these scenarios, but may be applied to any other scenarios.

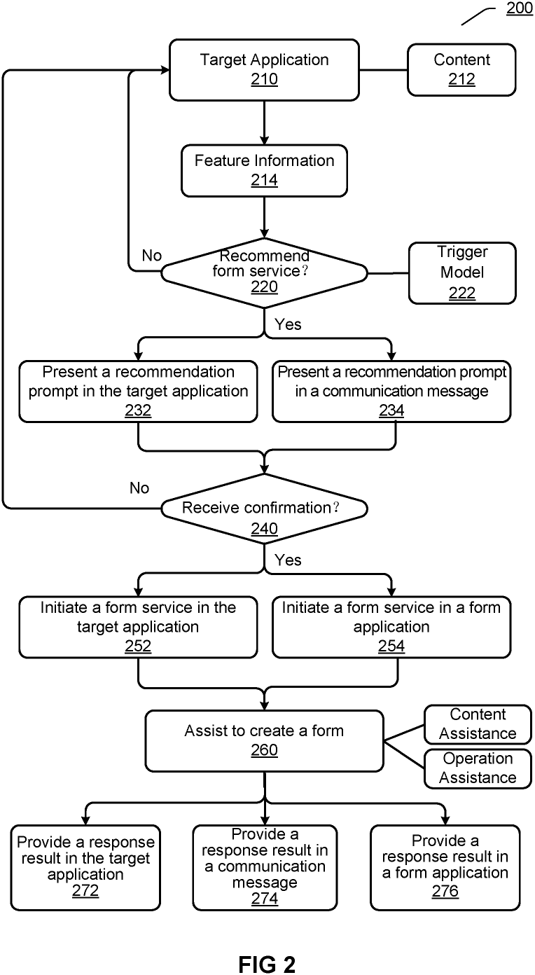

FIG. 2 illustrates an exemplary process 200 for providing form service assistance according to an embodiment.

A user may use a target application 210 to process content 212. Content may refer to various types of data or information that can be processed in a target application. For example, assuming that the target application 210 is an email service, the content 212 may include an email, and the user may use the email service to edit or view the email. Assuming that the target application 210 is a calendar application, the content 212 may include various calendar items in the calendar application, and the user may use the calendar application to create or edit calendar items, e.g., create a meeting item, etc.

Feature information 214 corresponding to the content 212 may be extracted in the target application 210. The feature information 214 may include various types of information that is in the content 212 or associated with the content 212 and facilitates to provide form service assistance, e.g., various types of information that facilitates to identify whether the user has a potential need of a form service, various types of information that facilitates to assist the usage of the form service, etc.

In an implementation, the feature information 214 may include keywords in the content 212. These keywords may include various words indicating that a form service may need to be used. In one aspect, the keywords may include words related to data collection intention, e.g., “survey”, “poll”, “selection”, “evaluation”, “opinion collection”, etc. In one aspect, the keywords may include words related to events. For some specific events, usually, corresponding types of forms may be created for these events to collect data from multiple event participants. The words related to events may include, e.g., “all-hands meeting”, “party”, “team travel”, etc. It should be understood that, in the embodiments of the present disclosure, the keywords extracted from the content 212 are not limited to the above examples, but may include any other types of words that facilitate to provide form service assistance.

In an implementation, the feature information 214 may include event information associated with an event in the content 212, which may also be referred to as event context information or event scene information. For example, if the keywords extracted from the content 212 relate to an event, various types of information about the event may be further obtained from the target application. In one aspect, the event information may be extracted from the content 212 directly. For example, assuming that the current content is a calendar item in a calendar application, “all-hands meeting, January 22, 2 p.m., participants: all 45 members in the department”, and the event keywords “all-hands meeting” are extracted, various types of event information about the event “all-hands meeting” may be further extracted from this calendar item, e.g., “event time = January 22, 2 p.m.,” “participants = all members in the department”, “number of participants = 45”, etc. In one aspect, the event information may be extracted from outside of the content 212 in the target application. For example, assuming that the current content is the body of an email in an email service, which involves collecting suggestions about restaurants for an event “ream lunch” from multiple participants, event information about names and number of participants of the event may be extracted from, e.g., “Recipient” region, event information about the number and names of restaurants suggested by other participants may be obtained from historical emails associated with this email, etc. It should be understood that, in the embodiments of the present disclosure, the event information is not limited to the above examples, but may include any other types of event information that are associated with different types of events and facilitate to provide form service assistance.

It should be understood that the feature information 214 is not limited to the examples described above, and it may also include any other types of information that facilitate to identify whether the user has a potential need of a form service.

At 220, it may be determined whether a form service for the content 212 should be recommended to the user based at least on the feature information 214. At least a part of information in the feature information 214 may facilitate to determine the user’s potential need of the form service.

In one aspect, the keywords related to data collection intention in the feature information 214 facilitate to determine the user’s potential need of the form service. Taking the keyword “opinion collection” as an example, if “opinion collection” appears in the expression of the content 212, it is very likely that the user may implement opinion collection from multiple recipients through a form. In one aspect, the keywords related to a specific event in the feature information 214 facilitate to determine the user’s potential need of the form service. Taking the event “all-hands meeting” as an example, usually, suggestions from the participants may be collected through a form before holding the all-hands meeting, feedbacks from the participants may be collected through a form after the end of the all-hands meeting, etc. Therefore, if “all-hands meeting” appears in the expression of the content 212, it is very likely that the user will hope to implement the collection of suggestions or feedbacks from the participants through a form.

In one aspect, at least a part of event information in the feature information 214 facilitates to determine the user’s potential need of the form service. Take the event information “number of participants” about the event “team lunch” as an example. If the number of participants is large, e.g., there are 30 participants, it will be efficient to collect data from these participants through the form service, and thus the user may have a need to use the form service. If the number of participants is small, e.g., there are only 3 participants, creating a form for the event may bring unnecessary burden to the user, and thus the user may not desire to use the form service. The above are just examples, and the feature information 214 may also include any other types of event information that facilitate to determine the user’s potential need of the form service.

If it is identified that the user has a potential need of the form service according to the feature information 214 or at least a part thereof, it may be determined to recommend the form service. For example, if the feature information 214 indicates that the user desires or needs to collect data from others, it may be determined that there is a potential need of the form service, so that a form service recommendation to the user may be triggered. In an implementation, a trigger model 222 may be adopted at 220 for determining whether to trigger the form service recommendation, i.e., whether to recommend the form service to the user. The trigger model 222 may be pre-established for identifying the user’s potential need of a form service based at least on the feature information 214, e.g.,, whether it is suitable to recommend the form service to the user, whether it is an appropriate timing to recommend the form service to the user, etc. If it is determined at 220 that the form service is not to be recommended, the process 200 may return to the target application 210 to continue to extract the feature information 214.

If it is determined at 220 that the form service is to be recommended, a recommendation prompt of the form service may be presented to the user. Text expression of the recommendation prompt may be predetermined, e.g., “Do you want to create a form?”, “Recommend you to use the form service”, etc. Optionally, the text expression of the recommendation prompt may be constructed by considering at least a part of the feature information 214, e.g., keywords. For example, assuming that the feature information 214 includes the keyword “all-hands meeting” extracted from the content 212, the recommendation prompt may be constructed as “Do you want to create a form for this all-hands meeting?”, etc. Optionally, the text expression of the recommendation prompt may further consider a specific form type which is to be recommended and corresponds to a specific event in the content 212. For example, assuming that the content 212 involves the event “all-hands meeting” and it is to recommend a form for collecting suggestions from participants before holding the all-hands meeting, the recommendation prompt may be constructed as “Do you want to create a form for collecting suggestions from participants before holding the all-hands meeting?”, etc. It should be understood that all the above recommendation prompts are exemplary, and the embodiments of the present disclosure are not limited to any specific text expressions of the recommended prompts. Moreover, the recommendation prompt is not limited to the format of text, and it may also take the format of image, audio, animation, etc. Further, the recommendation prompt may also include or be attached with controls that may be operated by the user to respond to the recommendation prompt, so that the user may confirm to initiate the form service, reject to initiate the form service, etc. The controls may take the shape of, e.g., button, on which annotations such as “agree”, “reject”, “yes”, “no”, “start”, etc. may be presented so that the user may selectively click them.

In an implementation, at 232, the recommendation prompt may be presented to the user in the target application 210. The recommendation prompt may be presented at various positions in the target application 210. For example, the recommendation prompt may be presented in a body region of the content 212. Taking the content 212 being an email as an example, the body region of the email may refer to, e.g., a region for editing the body of an email in a user interface of an email service. For example, the recommendation prompt may be presented in a sidebar region of the content 212. Taking the content 212 being an email as an example, the sidebar region of the email may refer to a region outside of the body region in the user interface of the email service for presenting help information or providing additional operations. For example, the recommendation prompt may be presented in a floating window in the target application 210. The floating window may be a window displayed above user interface elements of the target application 210 in a floating approach. It should be understood that the above only gives exemplary positions for presenting the recommendation prompt in the target application 210, and the recommendation prompt may also be presented at any other position in the target application 210.

In an implementation, at 234, the recommendation prompt may be presented to the user in a communication message. When it is determined at 220 that the form service is to be recommended to the user, a communication message may be sent to the user via a communication application, and the recommendation prompt may be included in the communication message. Taking the communication application being an email service as an example, an email including the recommendation prompt may be sent to the user, so that the user may view the recommendation prompt when browsing the email. It should be understood that the communication message used for presenting the recommendation prompt to the user is not limited to email, and may also include any other types of communication messages, e.g., social media message, cellphone short message, etc.

At 240, it may be determined whether a confirmation to the recommendation prompt is received from the user. As described above, the recommendation prompt may include or be attached with controls that may be operated by the user to respond to the recommendation prompt, thereby the user may indicate whether the user desires to initiate and use the form service by operating the controls. If it is determined at 240 that no confirmation to the recommendation prompt is received from the user, which indicates that the user may not desire to use the recommended form service, the process 200 may return to the target application 210 to continue to extract the feature information.

If it is determined at 240 that a confirmation to the recommendation prompt is received from the user, which indicates that the user desires to use the recommended form service, the process 200 may, in response to the confirmation, initiate the form service with at least the feature information 214. For example, the form service may be initiated by using the feature information 214 as initialization information or reference information, thereby, assistance for the usage of the form service may be provided based at least on the feature information 214 in the subsequent processing in the form service.

In one implementation, the form service may be initiated in the target application 210 at 252. In this case, the form service is provided in the target application 210 in an embedded approach, thereby the user may implement the usage of the form service in the target application 210.

In an implementation, the form service may be initiated in the form application at 254. In this case, e.g., when the user clicks a button for confirming to user the form service in the recommendation prompt, the user will be guided from the target application 210 to the form application to implement the usage of the form service in the form application.

After the form service is initiated, the creation of a form associated with the content 212 may be assisted at 260 based at least on the feature information 214. In one aspect, various types of content assistance related to form content may be provided based on the feature information 214, e.g., providing a suggested form, suggested questions, suggested options, etc. In one aspect, various types of operation assistance related to form operations may be provided based on the feature information 214, e.g., suggesting to add content items, suggesting to create a form distribution email, etc. Since the content assistance and the operation assistance are provided based at least on the feature information 214, the suggested content and operation will be associated with the content 212 processed by the user or the event concerned by the user, and thus the usage efficiency of the form service by the user may be effectively improved.

After the creation of the form is completed, the form may be distributed to multiple recipients. The form service may collect responses to the form from different responders. The process 200 may assist the form service to generate a response result and provide the response result to the user. The response result may simply include each responder’s answers to questions in the form. Moreover, the response result may also include one or more statistical analysis items which may be associated with the event targeted by the form or the purpose of the form. It is assumed that the form is created for the event “all-hands meeting” and used to collect feedbacks from participants after the end of the all-hands meeting. Multiple specific analysis items may be set for the response result of the form, e.g., an average rating by the responders, aspects that need to be kept up, aspects that need to be improved next time, etc. Data content of these analysis items may be generated through performing statistics on related questions and answers in the form. The response result may include an intermediate response result and/or a final response result. The intermediate response result may be a response result generated for responses that have been received within a form-responding time limit. At this point, some recipients may have already responded to the form, while other recipients have not completed their response to the form yet. The form-responding time limit may refer to a time period set for a form when the form is created, during which responses may be made, wherein recipients may respond to the form within the time period, but cannot respond to the form beyond the time period. The final response result may be a response result generated for all the responses that have been received after the form-responding time limit expires.

The response result may be provided to the user through various approaches. For example, the response result may be provided in the target application 210 at 272, thereby the user may view the response result in the target application 210. For example, the response result may be provided in a communication message at 274, thereby the user may view the response result while browsing the communication message. For example, the response result may be provided in the form application at 276, thereby the user may view the response result by accessing the form application. It should be understood that the response result may be provided to the form creator, and may also be provided to the form responders or the form recipients. Moreover, while providing the response result, operations suggested based on the response result may be additionally provided. It is assumed that the form is created for the event “team lunch” and used to collect selection opinions on restaurant from participants. If the response result indicates that most of the participants chose a restaurant M, it may be suggested accordingly, e.g., to create a notification email about holding the team lunch at the restaurant M in the email service, to create a calendar item about holding the team lunch at the restaurant M in the calendar application, etc. If the user confirms the suggested operation which is based on the response result, the process 200 may assist the user to perform related operations based at least on the feature information 214, e.g., creating a suggested email in the email service, creating a suggested calendar item in the calendar application, etc.

It should be understood that all the processing and steps in the process 200 discussed above are exemplary, and the processing and steps in the process 200 may be arbitrarily modified, replaced, added, etc. according to specific application scenarios and requirements. In one situation, the assistance to the form service may include creating a notification message for distributing the form based at least on the feature information. For example, when the creation of the form is completed in the form service, the user may be assisted in creating a distribution email for distributing the form to recipients. The distribution email may include a part of content in the feature information, e.g., event name, event time, recipients, etc., and may also include, e.g., suggested sending time, etc. In one situation, the assistance to the form service may include creating, based at least on the feature information and an intermediate response result of the form, a communication message for reminding the recipients to respond to the form. For example, when the intermediate response result indicates that only a few of the recipients responded, the user may be assisted in creating a reminder email to remind the recipients to respond to the form. The reminder email may include a part of content in the feature information, e.g., event name, event time, recipients, etc., and may also include, e.g., form-responding time limit, suggested sending time, etc.

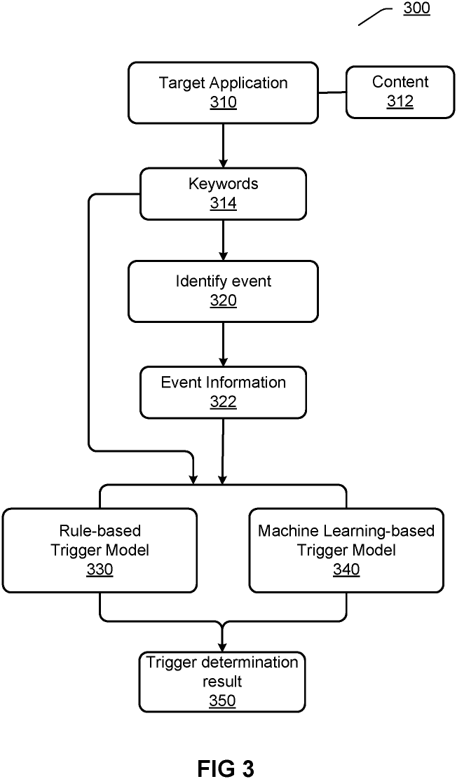

FIG. 3 illustrates an exemplary process 300 for triggering form service recommendation according to an embodiment. The process 300 may be performed for determining whether to recommend a form service to a user, which is further exemplary description of the determining of whether to recommend a form service based at least on feature information in FIG. 2.

It is assumed that a user uses a target application 310 to process content 312. Feature information corresponding to the content 312 may be extracted in the target application 310.

Keywords 314 may be extracted from the content 312. The keywords 314 may include words indicating that a form service may need to be used, words related to events, etc. In an implementation, a keyword list may be pre-established, and the keyword list may include multiple candidate keywords that facilitate to provide form service assistance. The keywords 314 included in the content 312 may be determined through matching the candidate keywords in the keyword list with the expression in the content 312.

At 320, an event in the content 312 may be identified based at least on the keywords 314. The extracted keywords 314 may include words related to an event, e.g., “all-hands meeting”, etc. Different events may have different levels of requirements for a form service, and different types of forms may be established for different events. The identifying of the event in the content 312 will facilitate to determine whether a form service needs to be used for the event, what type of form needs to be applied for the event, etc.

After the event is identified, event information 322 associated with the event may be further extracted in the target application 310. The event information may be various types of information associated with attribute, context, scenario, etc. of the event. The extracting of the event information 322 is not limited to the content 312 itself, and the event information associated with the event may also be extracted from other regions or content outside of the content 312 in the target application 310.

The extracted keywords 314 and event information 322 may be used as feature information to further determine whether to recommend a form service to the user. A trigger model may be adopted for determining whether to recommend a form service based at least on the feature information. The process 300 may adopt one or more trigger models, e.g., a rule-based trigger model 330, a machine learning-based trigger model 340, etc.

The rule-based trigger model 330 may include a rule set defined for feature information, which includes one or more predefined rules. In one aspect, various rules may be defined for keywords in the feature information that facilitate to determine a potential need of a form service. For example, keywords such as “poll”, “selection”, “all-hands meeting”, “opinion collection”, etc., may have relatively important indications in terms of determining a potential need of a form service, thus, rules may be defined for these keywords, e.g., whether the content contains a certain keyword, whether the content contains two or more keywords, whether the content contains keywords that have higher indications, etc. In another aspect, various rules may be defined for event information in the feature information that facilitates to determine a potential need of a form service. Taking the event information “number of participants” as an example, considering that the possibility of a potential need of a form service is usually proportional to the number of participants, thus, a threshold may be preset for the number of participants in a rule, and when the extracted number of participants exceeds the threshold, the rule may be considered to be satisfied, otherwise, the rule is not satisfied. In an implementation, when the rule-based trigger model 330 determines that the extracted feature information satisfies some or all of the rules in the rule set, it may be determined to trigger the recommendation of the form service. It should be understood that all the rules discussed above are exemplary, and in fact, the rule-based trigger model 330 may include more or less any other rules.

Moreover, the rule set adopted by the rule-based trigger model 330 may be evaluated and optimized through an evaluation mechanism. The evaluation mechanism may consider users’ responses to form service recommendations, e.g., whether a user browses a communication message including the recommendation prompt, whether a user confirms a recommendation prompt and creates a form, whether a user distributes a created form to recipients, etc. The evaluation mechanism may calculate one or more evaluation parameters used for evaluating the rule set, e.g., trigger rate, kept count, kept rate, etc. The trigger rate may refer to a ratio between the number of times the trigger model 330 determines to recommend a form service and the number of times the trigger model 330 is invoked to determine whether to recommend a form service. The kept count may refer to the number of kept operations performed by users with respect to form service recommendations, which may include, e.g., the number of times that communication messages containing recommendation prompts are browsed, the number of times that forms are created, the number of times that forms are distributed, etc. The kept rate may refer to a ratio between the kept count and the number of times the trigger model 330 determines to recommend a form service. At least one of these evaluation parameters may be used to evaluate the performance of the rule set adopted by the trigger model 330. For example, the trigger rate may indicate whether the trigger model 330 triggers form service recommendations too much or too little, the kept count may indicate whether enough users are impacted to use the form service, the kept rate may indicate whether form service recommendations are at the right time, etc. The evaluation mechanism may use the evaluation parameters to determine whether the rules in the rule set are valid, whether they need to be adjusted, whether they need to be added or removed, etc., so that the rule-based trigger model 330 may be improved.

The machine learning-based trigger model 340 may adopt a predetermined feature set for predicting whether a recommendation of a form service should be triggered. The feature set adopted by the trigger model 340 may include features corresponding to at least a part of the feature information 214, e.g., features corresponding to those feature information considered by the rule-based trigger model 330 when defining rules, etc. Optionally, the feature set adopted by the trigger model 340 may also include potential features. The potential features may correspond to any other information, except for the feature information, that facilitates to determine whether to trigger a form service recommendation, e.g., position of the meeting organizer, the total number of staff of the company or department that the user is in, whether the meeting is periodic or one-off, etc. Moreover, optionally, when selecting the features adopted by the trigger model 340, the status of the evaluating of the rule set adopted by the rule-based trigger model 330 through the evaluation mechanism described above may be considered, and features that correspond to those rules verified as valid by the evaluation mechanism may be selected. The machine learning-based trigger model 340 may be established based on various machine learning techniques, e.g., it may be a tree-based LGBM model, a neural network model, etc. The embodiments of the present disclosure are not limited to any specific approaches of establishing the trigger model 340, but may cover any machine learning model trained for predicting whether to trigger a form service recommendation based on the feature set described above.

In the process 300, any one or both of the rule-based trigger model 330 and the machine learning-based trigger model 340 may be adopted for outputting a trigger determination result 350, e.g., recommending a form service or not recommending a form service. In the case of adopting both the two models, the final trigger determination result 350 may be obtained by combining respective trigger determination results of the two models in any approaches, e.g., performing weighted summation to the respective trigger determination results of the two models to produce the final trigger determination result, selecting a trigger determination result with higher confidence from the respective trigger determination results of the two models as the final trigger determination result, etc.

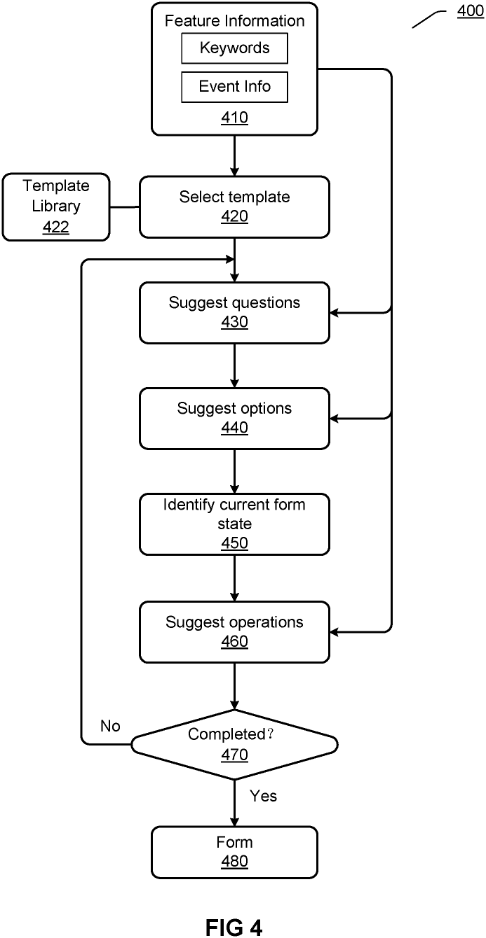

FIG. 4 illustrates an exemplary process 400 for assisting to create a form according to an embodiment. The process 400 is further exemplary description of the assisting to create a form at 260 in FIG. 2.

Feature information 410 may be extracted in a target application, which may include, e.g., keywords, event information, etc. The feature information 410 may correspond to, e.g., the feature information 214 in FIG. 2.

At 420, a template that would be applied to a form to be created may be selected from a template library 422 based at least on the feature information 410. The template library 422 may include a plurality of pre-designed form templates. Each form template may include one or more of: a predetermined design layout, a title template, a subtitle template, one or more question templates, an option template corresponding to each question template, etc. In some cases, a title and/or a subtitle in a form may be generated by filling at least a part of information in the feature information 410 into a title template and/or a subtitle template. Taking the title template “Survey for <event>” as an example, the “<event>” part may be replaced by extracted event keywords in the feature information 410, e.g. “all-hands meeting”, so that a corresponding title “Survey for all-hands meeting” may be constructed with the title template. In some cases, questions and options in a form may be generated by filling at least a part of information in the feature information 410 into question templates and option templates. Taking the question template “Did you attend the all-hands meeting held on <date>?” as an example, the “<date>” part may be replaced by extracted event time in the feature information 410, e.g., “January 22”, so that a corresponding question “Did you attend the all-hands meeting held on January 22?” may be constructed with the question template. Each form template may be associated with specific keywords and/or event information, and thus, e.g., different form templates may be pre-established for different events. For example, a form template associated with the event “all-hands meeting” may be established, which may be specifically used to collect feedbacks from participants, and accordingly may include multiple question templates, multiple option templates, etc. for collecting feedbacks from participants. For example, the question templates used to collect participant feedbacks may include “Please select your rating for this all-hands meeting”, and a corresponding option template may provide multiple ratings for selection. For example, the question templates used to collect participant feedbacks may include “Which of the following aspects are you most satisfied with regarding the all-hands meeting held on <date>?”, and a corresponding option template may provide multiple options for selection, e.g., “Topic selection”, “Meeting affairs”, etc. Moreover, each form template may be associated with a specific form purpose. For example, a form template used for conducting survey or quiz may include relatively more questions, while a form template used for polling may include few or even only one question, etc. After a form template is selected at 420, the selected form template may be used to assist the user to create and edit a form in the form service.

At 430, questions in the form may be suggested to the user. The suggested questions may be generated based at least on the feature information 410. In one aspect, as described above, a form template may be selected based on the feature information 410 first, and suggested questions may be generated with question templates in the form template. For example, a suggested question may be generated by filling at least a part of information in the feature information 410 into a question template. Moreover, when a question template itself provides a complete question without requiring to filling information therein, the question in the question template may be directly used as a suggested question. In one aspect, it may be considered whether the feature information 410 contains a specific type of information, and a corresponding question may be generated. For example, assuming that a form for collecting feedbacks from participants for the event “all-hands meeting” is to be created, if the feature information 410 includes information about names of speakers in the all-hands meeting, questions about satisfaction with the performance of these speakers may be generated, e.g., “Please select a speaker who you are satisfied with”.

At 440, options may be suggested to the user for the questions suggested at 430. Herein, an option may broadly refer to information or prompt included in a form, to which responders make reference when answering a specific question, e.g., a Likert candidate option, a rating candidate option, a text input prompt, etc. In one aspect, the suggested options may be generated based at least on the feature information 410. For example, for the question “Please select a speaker who you are satisfied with”, assuming that the feature information 410 includes information about names of multiple speakers, the names of these speakers may be suggested as candidate options. In one aspect, the suggested options may be generated based on predetermined knowledge. The predetermined knowledge may include information widely known in various domains, a specific answering pattern for a specific type of questions, etc., e.g., a week includes 7 days, working hours are usually from 9 a.m. to 5 p.m., a yes-no question may be answered by “Yes” or “No”, etc. For example, for the question “Which days do you usually take exercise in a week?”, 7 candidates from Monday to Sunday may be suggested based on the predetermined knowledge. In one aspect, while providing the suggested options, related information corresponding to the options may also be provided, which may be various types of descriptive information about the options for users’ reference. For example, if the options include names of multiple restaurants, relevant information about each candidate restaurant, e.g., address, phone number, mark on the map, customer reviews, etc., may be further provided. The relevant information of the options may be obtained by the form service from various information sources such as applications, websites, etc., and may adopt various formats such as text, images, etc.

The current form state may be identified at 450, and at 460, in response to the current form state, suggested operations are provided based at least on the feature information 410. The current form state may refer to the current content editing state of the form, the current operating state of the user on the form, etc. The suggested operations may be various operations that are helpful for the user to further edit or improve the form or further use the form service in the current form state, e.g., suggesting to add content items, suggesting to distribute the form, etc. For example, assuming that the current form state indicates that the user has stopped operations for a predetermined length of time, or the user browses all the questions, or the user has completed a preview of the whole form, etc., the user may be suggested to create a distribution email for distributing the form, and in this suggested operation, event participants obtained from the feature information 410 may be used as recipients of the distribution email, a predetermined time point before event time included in the feature information 410 may be used as a sending time point of the distribution email, etc. For example, assuming that the current form state indicates that the user has completed the editing of multiple questions in the form, the suggested operations may include suggesting the user to add a subtitle about estimated responding time to complete a response to the current form or set information about the estimated responding time in a subtitle, wherein the subtitle may be generated based at least on the feature information 410. The estimated responding time may be determined by predetermined criteria, e.g., based on the number of questions, the number of options, etc. in the current form. It should be understood that the estimated responding time may be continuously updated as the form is further edited, thus the operation suggestions about setting the estimated responding time may also be continuously updated. For example, assuming that the current form state indicates that a question being edited involves branches, the suggested operations may include suggesting the user to set up branch questions, wherein the branch questions may be generated based at least on the feature information 410.

At 470, it may be determined whether the creation of the form is completed based at least on the user’s instruction. When the user clicks a button such as “preview”, “share”, “distribute”, etc., it may be deemed that the creation of the form is completed, thus a form 480 is output. If the user clicks a button such as “create a new question”, etc., it may be determined that the creation of the form is not completed and the user desires to continue editing, thus the process 400 may return to 430 to provide the next suggested question. Through continuously and iteratively performing the process 400 in this approach, assistance may be provided throughout the process of creating the form by the user.

It should be understood that all the processing and steps in the process 400 discussed above are exemplary, and the processing and steps in the process 400 may be arbitrarily modified, replaced, added, etc. according to specific application scenarios and requirements. In one situation, the selecting of the form template at 420 may be omitted, thus a default template may be used when initiating the form service. In one situation, the form template selected at 420 may simply include only an event-specific predetermined design layout. In one situation, the suggestion for questions at 430 may be omitted, but suggested options may be provided in response to questions input by the user. In one situation, the suggestion for options at 440 may be omitted, and options input by the user may be adopted. In one situation, the step of identifying the current form state at 450 and/or the step of recommending operations at 460 may not be performed in each iteration of the process 400, but may be performed in response to specific trigger conditions, e.g., the steps at 450 and/or 460 are performed at a predetermined time period, the step at 460 are performed only when the current form state identified at 450 meets a predetermined condition, etc. In some situations, instead of giving suggestions on a question-by-question basis as shown in the process 400, a whole suggested form may be directly given based at least on the feature information 410, wherein the suggested form includes questions and options generated based at least on the feature information 410.

Specific examples of providing form service assistance according to the embodiments of the present disclosure will be given below in conjunction with specific application scenarios.

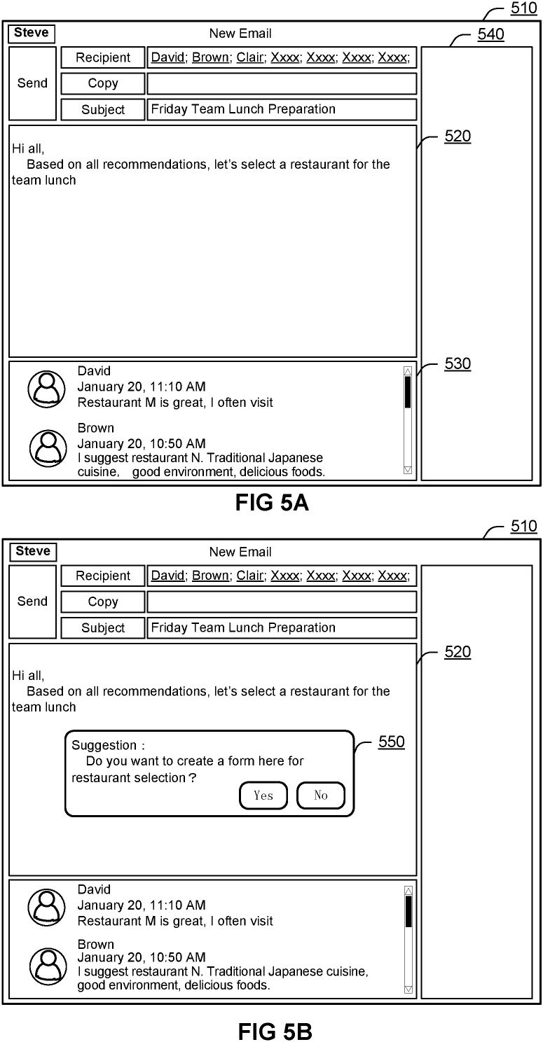

FIG. 5A to FIG. 5B illustrate an example of providing a recommendation prompt of a form service according to an embodiment.

In FIG. 5A, assuming that a user Steve is editing a new email in a user interface 510 of the email service which is a target application. The user interface 510 may include multiple regions, e.g., a body region 520 for editing the body of an email, a historical session region 530 for presenting historical emails associated with the new email, a sidebar region 540 for presenting additional information or performing additional operations, etc. Moreover, the user interface 510 may also include multiple other functional regions, e.g., a recipient region for inputting email addresses of recipients, a subject region for entering a subject of an email, etc.

In the exemplary scenario of FIG. 5, the user Steve desires to collect opinions on restaurant selection for “team lunch” from other team members through an email. As shown in the historical session region 530, the team members have provided some restaurant suggestions in previous historical emails, e.g., David suggested the restaurant M, Brown suggested the restaurant N, etc. The body of the email input by Steve in the body region 520 may be regarded as content in the target application. As shown in the body region 520, Steve has input the sentence “Based on all recommendations, let’s select a restaurant for the team lunch”. Moreover, Steve also have input email addresses of the team members, who are participants of the team lunch, in the recipient region, and has input the subject “Friday Team Lunch Preparation” in the subject region.

According to the embodiments of the present disclosure, feature information corresponding to the body of the email may be extracted. The feature information may include keywords such as “team lunch”, “select”, etc. extracted from the body of the email. The feature information may also include event information about the event “team lunch”, e.g., names, number and email addresses of participants extracted from the recipient region, event time “Friday” extracted from the subject region, restaurant names such as “Restaurant M”, “Restaurant N”, etc. extracted from the historical session region 530, and so on.

The extracted feature information indicates that the user Steve may have a potential need of collecting restaurant selections from the team members through a form service. Through, e.g., the step 220 in FIG. 2 or the process 300 in FIG. 3, it may be determined to recommend a form service to Steve for the body of the email being edited, based at least on the extracted feature information. A recommendation prompt of the form service may be presented to Steve in the user interface 510. As shown in FIG. 5B, an exemplary recommendation prompt 550 is presented in the body region 520. The recommendation prompt 550 may include a sentence about asking the user Steve if he desires to create a form for restaurant selection. The recommendation prompt 550 may also include buttons “Yes” and “No”, so that the user may indicate whether he desires to initiate the form service or rejects to initiate the form service by clicking the buttons. In the example of FIG. 5B, the recommendation prompt is presented in the body region of the target application. In this case, the email service has the processing capability of presenting a recommendation prompt.

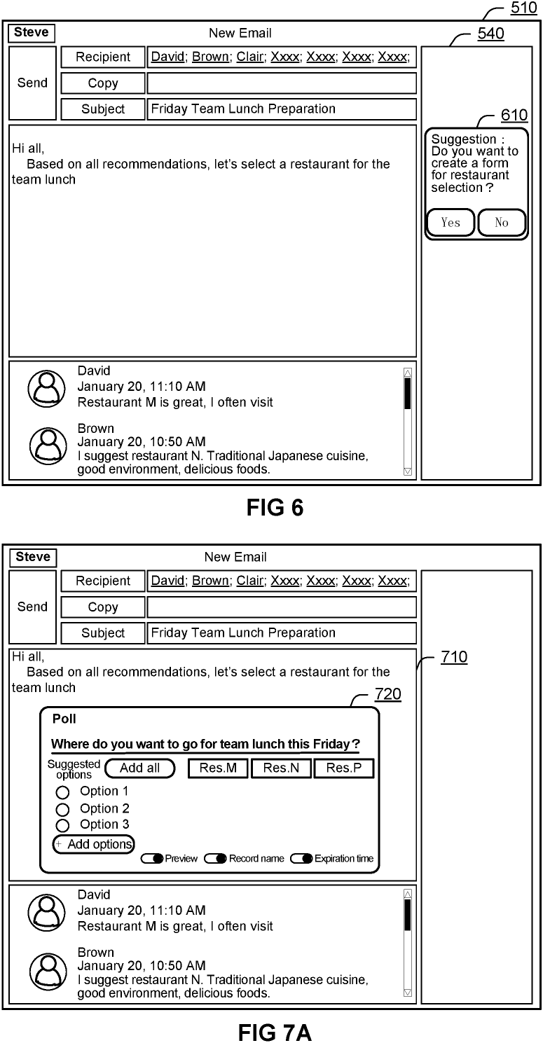

FIG. 6 illustrates an example of providing a recommendation prompt of a form service according to an embodiment. The example of FIG. 6 is a continuation of the example of FIG. 5A and acts as an alternative to the example of FIG. 5B. For example, if it is determined in the example of FIG. 5A to recommend a form service to Steve, then as shown in FIG. 6, a recommendation prompt 610 may be presented in the sidebar region 540 of the email service. The recommendation prompt 610 may be similar with the recommendation prompt 550 in FIG. 5B. In the example of FIG. 6, the recommendation prompt is presented in the sidebar region of the target application. In this case, the email service has the processing capability of presenting a recommendation prompt.

It is should be understood that the embodiments of the present disclosure are not limited to any specific details of the recommendation prompts in FIG. 5B and FIG. 6, but may include more or less any other information in the recommendation prompts.

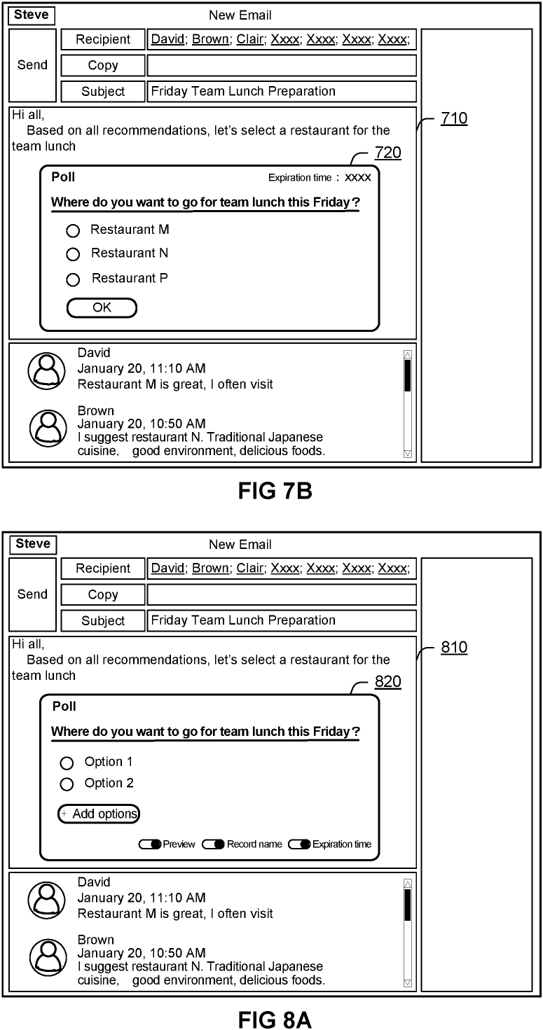

FIG. 7A to FIG. 7B illustrate an example of initiating a form service and assisting to create a form according to an embodiment. The example of FIG. 7A to FIG. 7B is a continuation of the example of FIG. 5B or FIG. 6.

Assuming that the user Steve clicks the button “Yes” in the recommendation prompt in FIG. 5B or FIG. 6 to confirm that he desires to use the recommended form service, the form service may be then initiated in the email service. Here, it is assumed that the email service has the processing capability of supporting the usage of the form service in an embedded approach. As shown in FIG. 7A, the form service is initiated in the email service, and a user interface 720 of the form service is displayed in a body region 710 of the email service. The form service is initiated with at least the feature information. As shown in the user interface 720, when the form service is initiated, it already includes various suggestions provided based on, e.g., the feature information extracted in FIG. 5A.

The creation of the form may be assisted by, e.g., the step 260 in FIG. 2 or the process 400 in FIG. 4. As shown in the user interface 720, a form template for the “poll” purpose has been selected based at least on the feature information, and suggested questions and suggested options are provided. When a form is used for “poll”, usually only a very few items or even one item will be polled on, therefore, a form template for the poll purpose may include, e.g., only one page. The suggested question “Where do you want to go for team lunch this Friday?” is generated based at least on the keyword “team lunch”, the event time “Friday”, etc., in the feature information. The suggested options “Restaurant M”, “Restaurant N”, “Restaurant P”, etc. are provided based on the event information extracted from the historical session region 530 in FIG. 5A. In FIG. 7A, the suggested options are not directly filled in the option region of the form, but are listed as reference information. If the user clicks the button “Add all”, the reference information will be automatically filled in the option region of the form to replace the currently displayed “Option 1”, “Option 2” and “Option 3” respectively. Moreover, the user interface 720 may also include other buttons that may be operated by the user to edit the form, e.g., “Add options”, “Preview”, “Record name”, “Expiration time”, etc. The “Add options” button may be clicked by the user to input other options. If the “Preview” button is clicked, the created form may be presented in the user interface 720. The “Record name” button is used to set whether to record names of responders who respond to the form. The “Expiration time” button is used to set the latest responding time for this form. It should be understood that all the above elements shown in the user interface 720 are exemplary, and the user interface 720 may also include any other elements according to specific application scenarios and requirements.

FIG. 7B shows that a final form is presented in the user interface 720 after the user completes the creation of the form and clicks the “Preview” button. The form is embedded in the email that is currently being edited. At this point, the user may click the “Send” button in the email service to distribute the email including the form to the recipients.

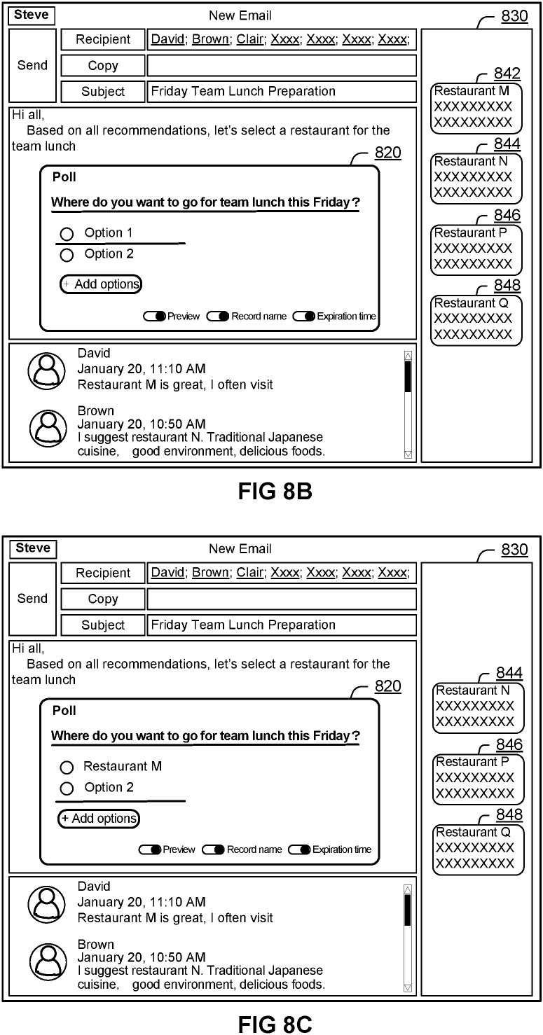

FIG. 8A to FIG. 8C illustrate an example of initiating a form service and assisting to create a form according to an embodiment. The example of FIG. 8A to FIG. 8C is a continuation of the example of FIG. 5B or FIG. 6, and acts as an alternative to the example of FIG. 7A to FIG. 7B.

Assuming that the user Steve clicks the button “Yes” in the recommendation prompt in FIG. 5B or FIG. 6 to confirm that he desires to use the recommended form service, the form service may be then initiated in the email service. As shown in FIG. 8A, the form service is initiated in the email service, and a user interface 820 of the form service is displayed in a body region 810 of the email service. The form service is initiated with at least the feature information. As shown in the user interface 820, when the form service is initiated, it already includes various suggestions provided based on, e.g., the feature information extracted in FIG. 5A.

The creation of the form may be assisted by, e.g., the step 260 in FIG. 2 or the process 400 in FIG. 4. As shown in the user interface 820, a form template for the “poll” purpose has been selected based at least on the feature information, and suggested questions are provided.

When the user edits options in an option region in the user interface 820, assistance may be provided. For example, if the user clicks “Option 1”, then as shown in FIG. 8B, multiple candidate options for “Option 1” may be presented in a sidebar region 830 of the email service, e.g., a candidate option 842 corresponding to the restaurant M, a candidate option 844 corresponding to the restaurant N, a candidate option 846 corresponding to the restaurant P, a candidate option 848 corresponding to the restaurant Q, etc. The information about restaurant names among these candidate options may be provided based on event information extracted from the historical session region 530 in FIG. 5A. Moreover, optionally, relevant information corresponding to the restaurant may also be included in each candidate option. For example, the candidate option 842 may include relevant information such as address, telephone number, customer reviews, etc., of the restaurant M. When the user is editing specific content of “Option 1”, the provided relevant information may provide reference for the user’s decision.

Assuming that the user clicks the candidate option 842 to indicate that he desires to use the restaurant M as “Option 1”, then as shown in FIG. 8C, “Restaurant M” is filled in the position of “Option 1” in the user interface 820. Meanwhile, the candidate options 844, 846 and 848 for “Option 2” are presented in the sidebar region 830 for the user to perform further selections. In such way, the user may be assisted to create a form, and the form, e.g., as shown in the user interface 720 in FIG. 7B will be obtained finally.

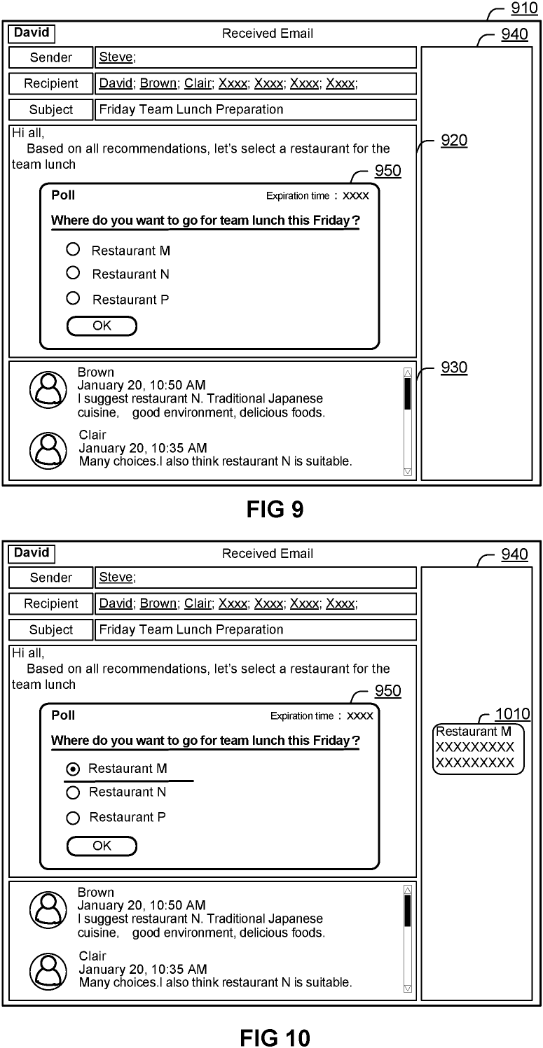

FIG. 9 illustrates an example of presenting a form at a form recipient according to an embodiment. It is assumed that the user Steve sends the email including the created form in the example of FIG. 7B, and a user David receives the email as one of the recipients.

In FIG. 9, it is assumed that the user David is browsing the email received from Steve in a user interface 910 of the email service. The user interface 910 may include a body region 920 for browsing a body of an email, a historical session region 930, a sidebar region 940, etc. As shown in the body region 920, the body of the email includes a user interface 950 that presents the form. The user David may respond to the form in the user interface 950. For example, the user David may select a desired option in the form, and then click the “OK” button to submit the response. In the example of FIG. 9, the form recipient may complete the responding to the form in the email service.

FIG. 10 illustrates an example of presenting a form at a form recipient according to an embodiment. The example of FIG. 10 is a further improvement of the example of FIG. 9. For example, when the user David clicks the option “Restaurant M” in the form, relevant information 1010 corresponding to the option may be presented in the sidebar region 940. The relevant information 1010 may include, e.g., address, telephone number, etc. of the restaurant M, for reference by the user David when responding to the form.

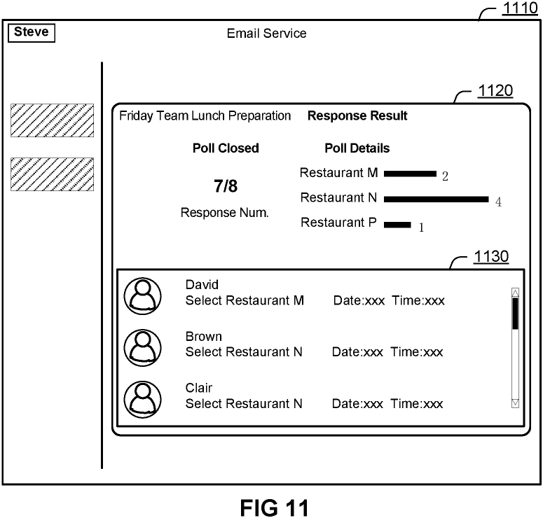

FIG. 11 illustrates an example of presenting a response result of a form at a form creator according to an embodiment. Assuming that the user Steve sends the email including the form in the example of FIG. 7B and the form service collects multiple responses to the form, a response result may be presented to the user Steve in the example of FIG. 11.

The user Steve may view the response result 1120 in a user interface 1110 of the email service. The response result 1120 may present responses from different responders in a region 1130, e.g., a responder David selects the restaurant M, a responder Brown selects the restaurant N, etc. Moreover, the response result 1120 may also include analysis items for the collected responses. For example, an analysis item “Response Number” indicates that 7 form recipients, among all the 8 form recipients, have responded. For example, an analysis item “Poll Details” indicates the number of votes obtained for each option, e.g., the option “Restaurant M” obtains 2 votes, the option “Restaurant N” obtains 4 votes, etc.

It should be understood that all the elements in the response result 1120 shown in FIG. 11 are exemplary, and the response result 1120 may include various other elements according to specific application scenarios and requirements, e.g., responses presented in different formats, different analysis items, etc.

Exemplary user interfaces for providing form service assistance in a scenario where a target application is an email service are given above in conjunction with FIG. 5A to FIG. 11. It should be understood that these exemplary user interfaces only correspond to a part of the process of providing form service assistance according to the embodiments of the present disclosure, and in actual application scenarios, there may be more or alternative user interfaces corresponding to any other parts of the process of providing form service assistance according to the embodiments of the present disclosure. In one situation, instead of recommending a form service to a sender who is about to send an email, a recommendation prompt of the form service may be presented at a recipient of the email. For example, when a recipient of an email is browsing a received email, feature information corresponding to the received email may be extracted, and if it is determined, based on the feature information, that a form service will be recommended, a recommendation prompt may be presented in a user interface of the email service at the email recipient, so that the email recipient may use the form service to create and distribute a form. In one situation, instead of presenting a user interface of a form service in a body region of the email service, the user interface of a form may be presented in a sidebar region of an email and the creation of the form may be performed in the sidebar region accordingly. In one situation, a form creator may be provided with continuously updated intermediate response results. In one situation, after a form responder submits a response, the current intermediate response result may be provided to the form responder.

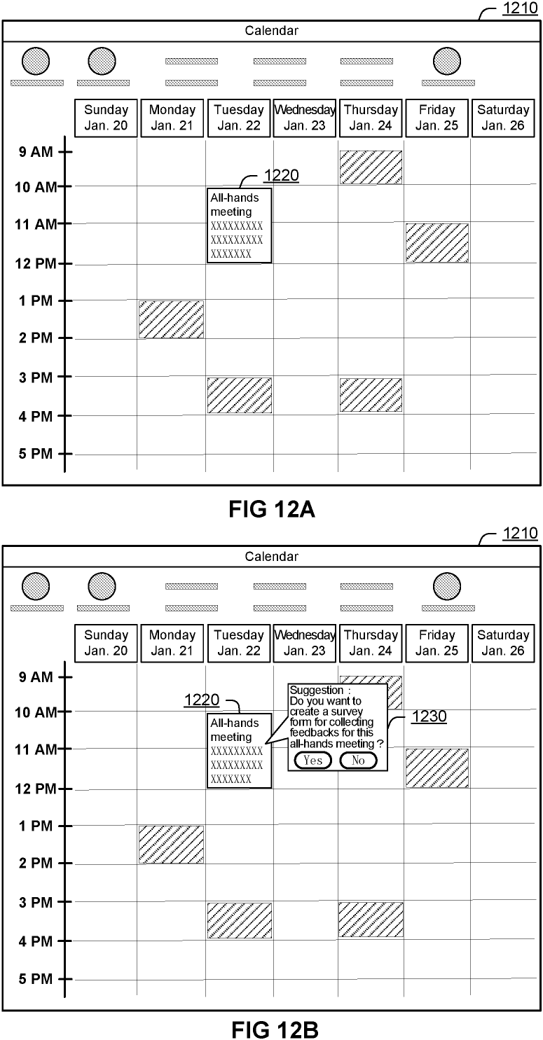

FIG. 12A to FIG. 12B illustrate an example of providing a recommendation prompt of a form service according to an embodiment.

In FIG. 12A, it is assumed that a user Steve is editing a new calendar item 1220 in a user interface 1210 of the calendar application which is a target application. It is assumed that the calendar item 1220 is about an all-hands meeting to be held from 10 a.m. to 12 a.m. on January 22, and may include meeting information such as meeting topic, participants, meeting location, speakers, etc. The calendar item 1220 may be regarded as content in the target application.

According to the embodiments of the present disclosure, feature information corresponding to the calendar item may be extracted. The feature information may include keywords such as “all-hands meeting”, etc. extracted from the calendar item 1220. The feature information may also include event information about the event “all-hands meeting”, e.g., meeting time “January 22” corresponding to the calendar item 1220 extracted from the calendar application, meeting topic, participants, meeting location, speakers, etc. extracted from the calendar item 1220, and so on.

The extracted feature information indicates that the user Steve may have a potential need of collecting feedbacks from meeting participants through a form service. Through, e.g., the operation at 220 in FIG. 2 or the process 300 in FIG. 3, it may be determined, based at least on the extracted feature information, to recommend a form service to Steve for the calendar item 1220 being edited. A recommendation prompt of the form service may be presented to Steve in the user interface 1210. As shown in FIG. 12B, an exemplary recommendation prompt 1230 is presented in the user interface 1210. The recommendation prompt 1230 may include a sentence about asking the user Steve if he desires to create a form for collecting feedbacks for the all-hands meeting. The recommendation prompt 1230 may also include buttons “Yes” and “No”, so that the user may indicate whether he desires to initiate the form service or reject to initiate the form service by clicking the buttons. In the example of FIG. 12B, the recommendation prompt is presented in a floating window in the target application. In this case, the calendar application has the processing capability of presenting a recommendation prompt.

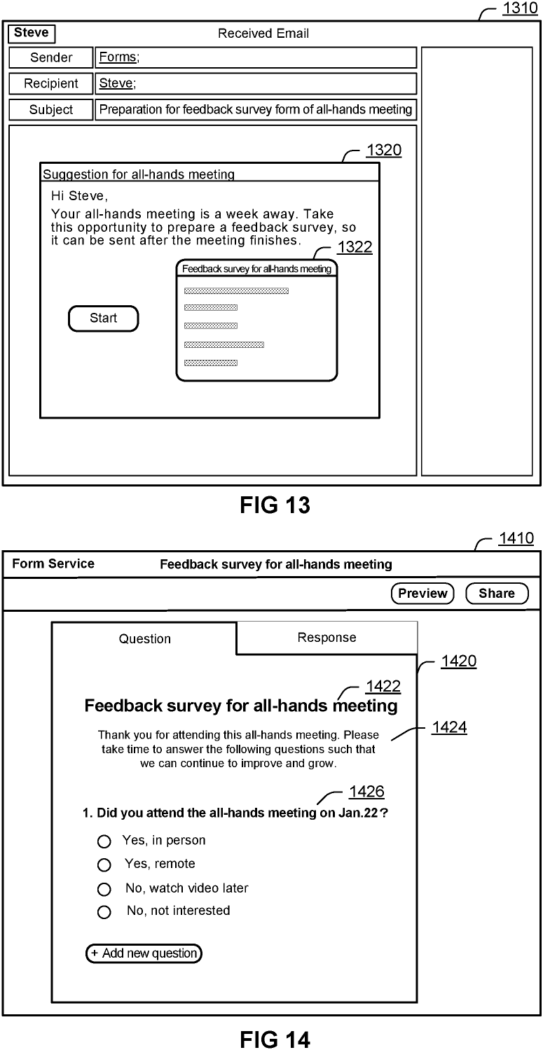

FIG. 13 illustrates an example of providing a recommendation prompt of a form service according to an embodiment. The example of FIG. 13 is a continuation of the example of FIG. 12A and acts as an alternative to the example of FIG. 12B. For example, if it is determined in the example of FIG. 12A to recommend a form service to Steve, a recommendation prompt may be presented in a communication message sent to the user Steve. As shown in FIG. 13, the user Steve may browse the received email in a user interface 1310 of the email service, wherein the email includes a recommendation prompt 1320. The email may be sent by an entity for triggering the form service, e.g., a form application or a calendar application. The recommendation prompt 1320 may include a sentence about asking the user if he desires to create a form for collecting feedbacks for the all-hands meeting. The recommendation prompt 1320 may also include, e.g., a button “Start”, so that the user may confirm that he desires to initiate the form service by clicking the button. Optionally, the recommendation prompt 1320 may also include an example region 1322, wherein the example region 1322 may present, e.g., a preview of a suggested form, an exemplary form, etc. In the example of FIG. 13, the recommendation prompt is presented in the communication message sent to the user of the target application. In this case, the calendar application may not have the processing capability of presenting a recommendation prompt.

It should be understood that the embodiments of the present disclosure are not limited to any specific details of the recommendation prompts in FIG. 12B and FIG. 13, but may include more or less any other information in the recommendation prompt.

FIG. 14 illustrates an example of initiating a form service and assisting to create a form according to an embodiment.

Assuming that the user Steve clicks the button “Yes” in the recommendation prompt 1230 in FIG. 12B or clicks the button “Start” in the recommendation prompt 1320 in FIG. 13 to confirm that he desires to use the recommended form service, the form service may be then initiated in a form application. In this case, the calendar application may not have the processing capability of supporting the usage of the form service. As shown in FIG. 14, the form service is initiated in a user interface 1410 of the form application, and a form region 1420 is presented. The form service is initiated with at least the feature information. As shown in the user interface 1410, when the form service is initiated, it already includes various suggestions provided based on, e.g., the feature information extracted in FIG. 12A.

The creation of the form may be assisted by, e.g., the step 260 in FIG. 2 or the process 400 in FIG. 4. As shown in the form region 1420 in the user interface 1410, a form template for the “survey” purpose and for collecting feedbacks for a meeting has been selected based at least on the feature information. When a form is used to conduct a “survey” that involves collecting feedbacks, the form usually collects data for multiple items, therefore, the form template may include one or more pages. In the form region 1420, a suggested title 1422, a suggested subtitle 1424, suggested questions and options 1426, etc. are provided. The suggested title 1422 and the suggested subtitle 1424 may be generated based at least on the keyword “all-hands meeting”, etc., in the feature information. The suggested question “Did you attend the all-hands meeting on January 22?” is generated based at least on the keyword “all-hands meeting”, the event time “January 22”, etc., in the feature information. The suggested options for this question may be provided based at least on predetermined knowledge, wherein the predetermined knowledge includes several common ways of participating in a meeting, e.g., on-site participation, remote participation, etc. Moreover, the form region 1420 may also include other buttons that may be operated by the user to edit the form, e.g., “Add new question”, etc. The “Add new question” button may be clicked by the user to input further questions. Moreover, the user interface 1410 may also include buttons that may be operated by the user to edit the form, e.g., “Preview”, “Share”, etc. If the “Preview” button is clicked, the created form may be presented in the user interface 1410. The “Share” button is used to generate a link for the form, create a distribution email, etc. It should be understood that all the above elements shown in the user interface 1410 and the form region 1420 are exemplary, and the user interface 1410 and the form region 1420 may also include any other elements according to specific application scenarios and requirements.

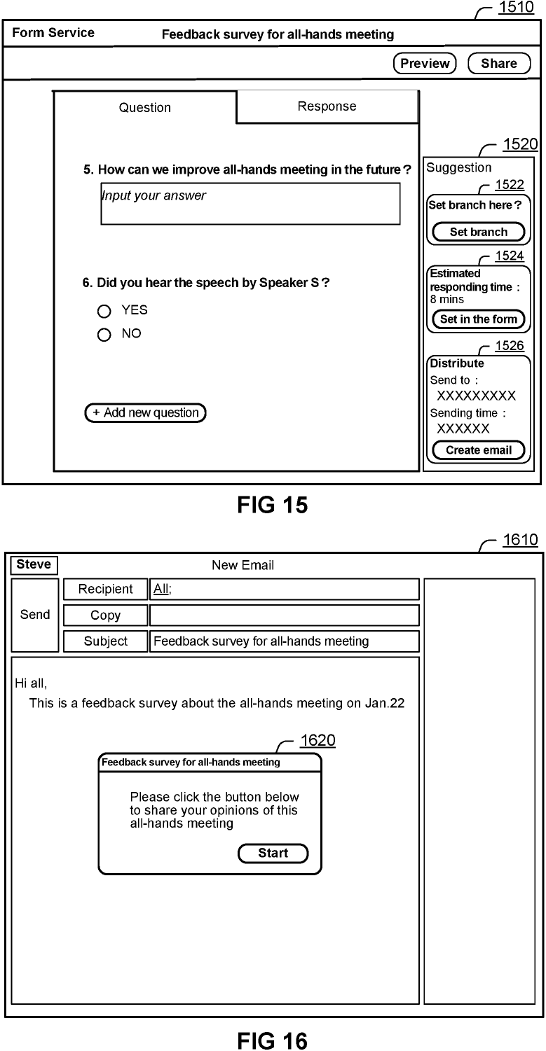

FIG. 15 illustrates an example of assisting to create a form according to an embodiment. The example of FIG. 15 is a continuation or improvement of the example of FIG. 14.

It is assumed that the user is editing the form in a user interface 1510 of the form application, and proceeds to the sixth question “Did you hear the speech by Speaker S?”. According to the embodiments of the present disclosure, the current form state may be identified through, e.g., the step 450 and step 460 in FIG. 4, and in response to the current form state, suggested operations may be provided based at least on the feature information. For example, an operation suggestion region 1520 including a plurality of suggestions is presented in the user interface 1510. The operation suggestion region 1520 may include an operation suggestion 1522 about setting up branch questions. The currently edited sixth question involves branches, and different further questions may be asked based on responders’ different answers to the sixth question. For a responder who selected “Yes”, a question such as “Are you satisfied with the speech by Speaker S?” may be further proposed, and for a responder who selected “No”, a question such as “Why didn’t you listen to the speech by Speaker S?” may be further proposed. If the user clicks the button “Set branch” in the operation suggestion 1522, the user may be assisted to establish corresponding branch questions. Optionally, the operation suggestion region 1520 may include an operation suggestion 1524 about setting an estimated responding time in the form. For example, when the user edits the sixth question, the estimated responding time of the form is updated accordingly, so that the user may be suggested to set the updated estimated responding time in the form. If the user clicks the button “Set in the form” in the operation suggestion 1524, the user may be assisted to include the estimated responding time in the suggested subtitle. Optionally, the operation suggestion region 1520 may include an operation suggestion 1526 about creating an email for distributing the form. The operation suggestion 1526 may include, e.g., suggested recipients, a suggested sending time, etc. If the user clicks the button “Create email” in the operation suggestion 1526, the user may be assisted to create an email for distributing the form. In the example of FIG. 15, suggested operations may be provided to the user during the user is using the form service. It should be understood that all the suggested operations in FIG. 15 are exemplary, and more or less any other operation suggestions may be provided to the user according to specific application scenarios and requirements.

FIG. 16 illustrates an example of assisting to create a distribution email according to an embodiment. Assuming that the user Steve clicks the button “Create email” in the operation suggestion 1526 in FIG. 15, a suggested distribution email may be presented to the user Steve in the email service. As shown in FIG. 16, a new email for distributing the form has been created automatically, on behalf of the user Steve, in a user interface 1610 of the email service. The distribution email is created based at least on the feature information. For example, based at least on the participant information in the feature information, email addresses of recipients are automatically filled in the recipient region. Based at least on the keyword “all-hands meeting” in the feature information, a subject is automatically filled in the subject region. A body of the email is created based at least on the keyword “all-hands meeting”, the event time “January 22”, etc., in the feature information. Moreover, the body of the email also includes a notification region 1620 about the form. The notification region 1620 includes a title of the form “Feedback survey for all-hands meeting”, an introductory sentence about the form “Please click the button below to share your opinions of this all-hands meeting”, etc. The notification region 1620 also includes a button “Start”, and if a recipient of the distribution email clicks the button “Start”, the recipient may be directed to a form application to respond to the form. The user Steve may click the button “Send” in the user interface 1610 to send the distribution email to the participants of the all-hands meeting.

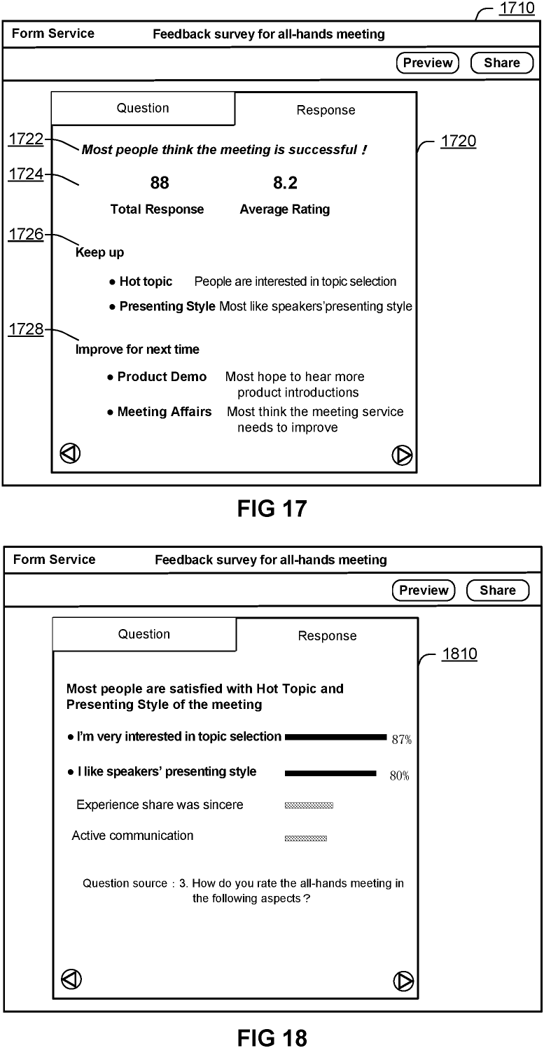

FIG. 17 to FIG. 18 illustrate an example of presenting a response result of a form according to an embodiment. Assuming that the user Steve sends the distribution email including the form in the example of FIG. 16 and the form service collects multiple responses to the form, the user Steve may then obtain a response result of the form by accessing the form application.

A response result 1720 may be presented in a user interface 1710 of the form application. As an example, the response result 1720 may include a plurality of analysis items 1722 to 1728. The analysis item 1722 is a summary based on an average rating by all the responders, e.g. “Most people think the meeting is successful!”. The analysis item 1724 includes the total number “88” of responses and the average rating “8.2” by all the responders, wherein the average rating “8.2” is a relatively high score. The analysis item 1726 relates to aspects that are given higher ratings by the responders and are desired to keep up, e.g., this all-hands meeting obtained higher ratings in terms of “Hot Topic” and “Presenting Style”. The analysis item 1728 relates to aspects that are given lower ratings by the responders and are desired to improve for next time, e.g., this all-hands meeting obtained lower ratings in terms of “Product Demo” and “Meeting Affairs”. Some analysis items in the response result 1720 are specifically given for the event “all-hands meeting”, e.g., the analysis items 1726 and 1728, and these event-specific analysis items may better provide evaluations based on attributes specific to the event and help the form creator to better understand the feedbacks from the participants.

The response result may include more than one page. The response result 1720 in FIG. 17 may be used as a page for a result of overall analysis of all the responses, and pages for specific statistical data for certain aspects may be further provided. For example, in FIG. 18, specific statistical data about which aspects of the meeting the participants are satisfied with is shown on a page of a response result 1810. The response result 1810 shows poll results from the responders on different aspects, e.g., responders who are satisfied with “Topic Selection” account for 87% of all the responders, responders who are satisfied with the speakers′, “Presenting Style” account for 80% of all the responders, etc. The poll results in the response result 1810 may be used as the basis for the analysis item 1726 in FIG. 17, e.g., the two aspects that have obtained the most votes in the response result 1810 are presented in the analysis item 1726. Moreover, the response result 1810 also gives questions associated with the listed poll results, e.g., the third question “How do you rate the all-hands meeting in the following aspects?”, i.e., the poll results in the response result 1810 are obtained through performing statistics to answers from the responders to the third question.

It should be understood that all the elements in the response results shown in FIG. 17 and FIG. 18 are exemplary, and the response results may include various other elements according to specific application scenarios and requirements, e.g., various other statistical data provided in various presentation formats, etc. The embodiments of the present disclosure are not limited in terms of specific content in the response results.

Exemplary user interfaces for providing form service assistance in a scenario where a target application is a calendar application are given above in conjunction with FIG. 12A to FIG. 18. It should be understood that these exemplary user interfaces only correspond to a part of the process of providing form service assistance according to the embodiments of the present disclosure, and in actual application scenarios, there may be more or alternative user interfaces corresponding to any other parts of the process of providing form service assistance according to the embodiments of the present disclosure. In one situation, instead of determining whether to recommend a form service while the user Steve is editing the calendar item 1220 in the calendar application, calendar items in the calendar application may be monitored periodically, and as long as a calendar item for which a form service may be recommended is found, a recommendation prompt is presented to the user. In one situation, within the form-responding time limit, the user may be automatically notified via an email to create a reminder email when a predetermined condition is met, so as to remind the recipients of the form to respond to the form. The predetermined condition may be, e.g., reaching a predetermined time point before expiration of the form-responding time limit, the number of responses that have been received being lower than a threshold, etc. Various approaches may be used to assist the user to create a reminder email, e.g., providing a suggested reminder email based at least on the feature information in an approach similar with assisting the user to create the distribution email, providing a suggested reminder email by simply copying the distribution email, etc. In one situation, the response result provided to the user may be an intermediate response result, i.e., the currently collected response result may be reported to the user before the form-responding time limit has been reached. In one situation, the response result may also be presented to the user through an email. Moreover, interactions with the user are not limited to emails, and any other types of communication messages, e.g., social network message, cellphone short message, etc., may also be adopted.

Moreover, it should be understood that, in the embodiments of the present disclosure, the target application is not limited to the email service and the form application shown in FIG. 5A to FIG. 18, and may also include any other types of productivity tools.

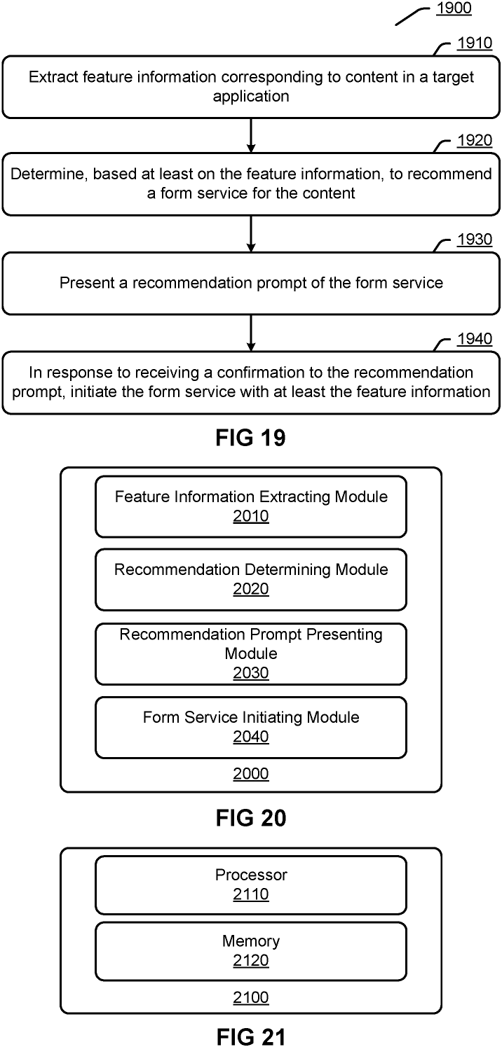

FIG. 19 illustrates a flowchart of an exemplary method 1900 for providing form service assistance according to an embodiment.

At 1910, feature information corresponding to content in a target application may be extracted.

At 1920, it may be determined, based at least on the feature information, to recommend a form service for the content.

At 1930, a recommendation prompt of the form service may be presented.

At 1940, in response to receiving a confirmation to the recommendation prompt, the form service may be initiated with at least the feature information.

In an implementation, the feature information may comprise at least one of: keywords in the content; and event information associated with an event in the content.

In an implementation, the determining to recommend a form service may comprise: determining to recommend the form service based at least on the feature information through a trigger model. The trigger model may comprise a rule-based trigger model and/or a machine learning-based trigger model.

The rule-based trigger model may comprise at least one rule defined for at least a part of the feature information.

The machine learning-based trigger model may adopt at least one feature corresponding to at least a part of the feature information.

In an implementation, the recommendation prompt may be presented in the target application. The recommendation prompt may be provided in at least one of: a body region of the content, a sidebar region of the content, and a floating window.

In an implementation, the recommendation prompt may be presented in a communication message sent to a user of the target application. The communication message may comprise at least one of: email, social media message, and cellphone short message.

In an implementation, the initiating the form service may comprise: initiating the form service in the target application with at least the feature information; or initiating the form service in a form application with at least the feature information.

In an implementation, the method 1900 may further comprise: assisting, in the form service, to create a form associated with the content based at least on the feature information.

The assisting to create a form may comprise at least one of: providing suggested questions based at least on the feature information; providing suggested options based at least on the feature information and/or predetermined knowledge; providing relevant information corresponding to the suggested options; providing a suggested form based at least on the feature information; and providing suggested operations based at least on the feature information.

The method 1900 may further comprise: providing a response result of the form and/or operations suggested based at least on the response result of the form, in the target application, a form application or a communication message.

The method 1900 may further comprise at least one of: creating, based at least on the feature information, a communication message for distributing the form; and creating, based at least on the feature information and an intermediate response result of the form, a communication message for reminding to respond to the form.

In an implementation, the form service may be applied for performing at least one of survey, poll and quiz, and the target application may be a productivity tool.

It should be appreciated that the method 1900 may further comprise any steps/processes for providing form service assistance according to the embodiments of the present disclosure as mentioned above.

FIG. 20 illustrates an exemplary apparatus 2000 for providing form service assistance according to an embodiment.

The apparatus 2000 may comprise: a feature information extracting module 2010, for extracting feature information corresponding to content in a target application; a recommendation determining module 2020, for determining, based at least on the feature information, to recommend a form service for the content; a recommendation prompt presenting module 2030, for presenting a recommendation prompt of the form service; and a form service initiating module 2040 for, in response to receiving a confirmation to the recommendation prompt, initiating the form service with at least the feature information.

In an implementation, the recommendation determining module 2020 may be for: determining to recommend the form service based at least on the feature information through a trigger model. The trigger model may comprise a rule-based trigger model and/or a machine learning-based trigger model.

In an implementation, the recommendation prompt may be presented in the target application, or in a communication message sent to a user of the target application.

In an implementation, the form service initiating module 2040 may be for: initiating the form service in the target application with at least the feature information; or initiating the form service in a form application with at least the feature information.

Moreover, the apparatus 2000 may also comprise any other modules configured for performing any steps and operations of the methods for providing form service assistance according to the embodiments of the present disclosure as mentioned above.

FIG. 21 illustrates an exemplary apparatus 2100 for providing form service assistance according to an embodiment.

The apparatus 2100 may comprise at least one processor 2110 and a memory 2120 storing computer-executable instructions. When executing the computer-executable instructions, the at least one processor 2110 may: extract feature information corresponding to content in a target application; determine, based at least on the feature information, to recommend a form service for the content; present a recommendation prompt of the form service; and in response to receiving a confirmation to the recommendation prompt, initiate the form service with at least the feature information. The at least one processor 2110 may be further configured for performing any operations of the methods for providing form service assistance according to the embodiments of the present disclosure as mentioned above.

The embodiments of the present disclosure may be embodied in a non-transitory computer-readable medium. The non-transitory computer-readable medium may comprise instructions that, when executed, cause one or more processors to perform any operations of the methods for providing form service assistance according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for providing form service assistance, comprising:
extracting feature information corresponding to content in a target application;
determining, based at least on the feature information, to recommend a form service for the content;
presenting a recommendation prompt of the form service; and
in response to receiving a confirmation to the recommendation prompt, initiating the form service with at least the feature information.

2. The method of claim 1, wherein the feature information comprises at least one of:
keywords in the content; and
event information associated with an event in the content.

3. The method of claim 1, wherein the determining to recommend a form service comprises:
determining to recommend the form service based at least on the feature information through a trigger model, and
wherein the trigger model comprises a rule-based trigger model and/or a machine learning-based trigger model.

4. The method of claim 3, wherein
the rule-based trigger model comprises at least one rule defined for at least a part of the feature information.

5. The method of claim 3, wherein
the machine learning-based trigger model adopts at least one feature corresponding to at least a part of the feature information.

6. The method of claim 1, wherein
the recommendation prompt is presented in the target application.

7. The method of claim 6, wherein
the recommendation prompt is provided in at least one of: a body region of the content, a sidebar region of the content, and a floating window.

8. The method of claim 1, wherein
the recommendation prompt is presented in a communication message sent to a user of the target application.

9. The method of claim 1, wherein the initiating the form service comprises:
initiating the form service in the target application with at least the feature information; or
initiating the form service in a form application with at least the feature information.

10. The method of claim 1, further comprising:
assisting, in the form service, to create a form associated with the content based at least on the feature information.

11. The method of claim 10, wherein the assisting to create a form comprises at least one of:
providing suggested questions based at least on the feature information;
providing suggested options based at least on the feature information and/or predetermined knowledge;
providing relevant information corresponding to the suggested options;
providing a suggested form based at least on the feature information; and
providing suggested operations based at least on the feature information.

12. The method of claim 10, further comprising:
providing a response result of the form and/or operations suggested based at least on the response result of the form, in the target application, a form application or a communication message.

13. The method of claim 10, further comprising at least one of:
creating, based at least on the feature information, a communication message for distributing the form; and
creating, based at least on the feature information and an intermediate response result of the form, a communication message for reminding to respond to the form.

14. An apparatus for providing form service assistance, comprising:
a feature information extracting module, for extracting feature information corresponding to content in a target application;
a recommendation determining module, for determining, based at least on the feature information, to recommend a form service for the content;
a recommendation prompt presenting module, for presenting a recommendation prompt of the form service; and
a form service initiating module for, in response to receiving a confirmation to the recommendation prompt, initiating the form service with at least the feature information.

15. An apparatus for providing form service assistance, comprising:
at least one processor; and
a memory storing computer-executable instructions that, when executed, cause the at least one processor to:
extract feature information corresponding to content in a target application,
determine, based at least on the feature information, to recommend a form service for the content,
present a recommendation prompt of the form service, and
in response to receiving a confirmation to the recommendation prompt, initiate the form service with at least the feature information.
